(19) United States
(12) Patent Application Publication
(10) Pub. No.: US 2013/0282760 A1
(43) Pub. Date: Oct. 24, 2013

(54) Apparatus and Method for Random Database Sampling with Repeatable Results

(71) Applicants: Bhargav Madhav Pendse, Pune (IN); Matthew Scott Wood, Salt Lake City, UT (US); Neil Richard Terry, Cedar Hills, UT (US)

(72) Inventors: Bhargav Madhav Pendse, Pune (IN); Matthew Scott Wood, Salt Lake City, UT (US); Neil Richard Terry, Cedar Hills, UT (US)

(73) Assignee: SOLERA NETWORKS INC., South Jordan, UT (US)

(21) Appl. No.: 13/451,503

(22) Filed: Apr. 19, 2012

(51) Int. Cl. G06F 17/30

(52) U.S. Cl. 707/780; 707/E17.014

(57) ABSTRACT

A method of sampling data in a database includes designating permanent read locations in a database. The database is populated with randomly loaded data. The permanent read locations in the database are sampled to form sampled repeatable results attributable to the permanent read locations and the randomly loaded data.

### FIELD OF THE INVENTION

This invention relates generally to information storage and retrieval. More particularly, this invention relates to a technique for random database sampling with repeatable results.

### BACKGROUND OF THE INVENTION

A database is an organized collection of digital data. A database management system enforces data quality in a database, which is measured in terms of accuracy, availability, usability and resilience.

A data warehouse is a database used for reporting and analysis. The data stored in the data warehouse is uploaded from an operational database. A data warehouse maintains data history. A data warehouse may integrate data from multiple source systems. Consequently, a data warehouse may generate unruly volumes of data. This makes it difficult to identify characteristics of the data since data characterization requires processing of such a large volume of data. To address this issue, one may randomly sample data. Random sampling provides a characterization of data in a large data store, but it does not provide repeatable results since each sampling iteration accesses different data.

In view of the foregoing, it would be desirable to provide a technique for random database sampling with repeatable results.

### SUMMARY OF THE INVENTION

A method of sampling data in a database includes designating permanent read locations in a database. The database is populated with randomly loaded data. The permanent read locations in the database are accessed to form sampled repeatable results attributable to the permanent read locations and the randomly loaded data.

A non-transitory computer readable storage medium includes executable instructions to sort data segments by identifiers to form pairs of identifiers and corresponding data segments. An attribute is ascribed to each data segment to form pairs of identifiers and corresponding attributes. The pairs of identifiers and corresponding attributes are randomly loaded into a database.

### BRIEF DESCRIPTION OF THE FIGURES

The invention is more fully appreciated in connection with the following detailed description taken in conjunction with the accompanying drawings, in which:

FIG. 1 illustrates a computer configured in accordance with an embodiment of the invention.

FIG. 2 illustrates processing operations associated with an embodiment of the invention.

FIG. 3 illustrates a system that implements an embodiment of the invention.

FIG. 4 illustrates processing operations associated another embodiment of the invention.

FIG. 5 illustrates data collection and organization utilized in accordance with an embodiment of the invention.

FIG. 6 illustrates a database with randomly inserted data in accordance with an embodiment of the invention.

Like reference numerals refer to corresponding parts throughout the several views of the drawings.

### DETAILED DESCRIPTION OF THE INVENTION

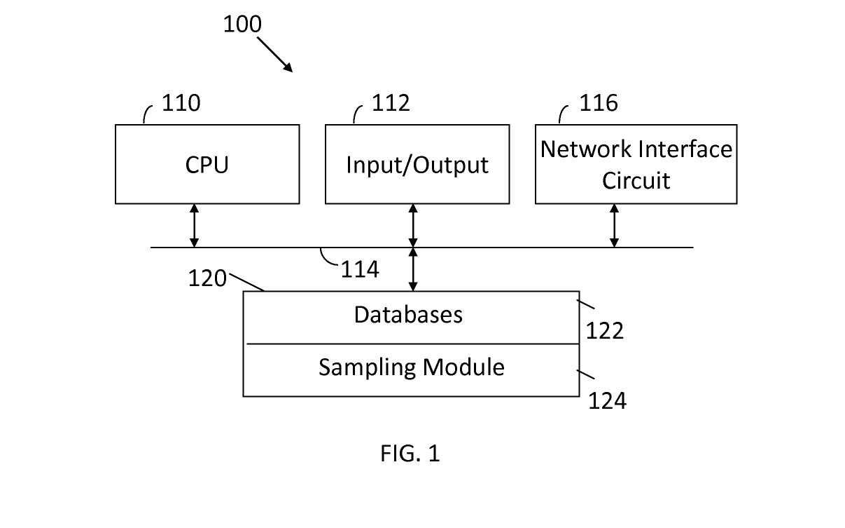

FIG. 1 illustrates a computer 100 configured in accordance with an embodiment of the invention. The computer 100 includes standard components, such as a central processing unit 110 and input/output devices 112 connected via a bus 114. The input/output devices 112 may include a keyboard, mouse, display and the like. A network interface circuit 116 is also connected to the bus 114. Therefore, the computer 100 may operate in a networked environment. A memory 120 is also connected to the bus 114. The memory stores one or more databases 122. A sampling module 124 is also stored in memory 120. The sampling module 124 includes executable instructions to implement operations of the invention. In particular, the sampling module 124 includes executable instructions to randomly load records into a database and then access the records to provide sampled repeatable results, as demonstrated below.

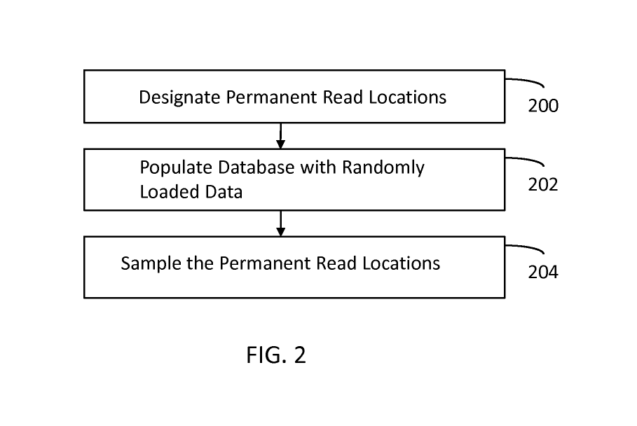

FIG. 2 illustrates operations that may be performed by the sampling module 124. The sampling module 124 designates permanent read locations for sampling 200. The sampling module 124 then populates a database with randomly loaded data 202. The sequence of operations 200 and 202 may be reversed. Finally, the database is sampled at the permanent read locations 204. This results in sampled data that characterizes the database. In the case of a data warehouse or other large data store that permanently stores static values, the technique of the invention allows repeatable sampled results. Unlike the prior art which samples from random database locations, the invention may access permanent read locations. Consequently, the same data is sampled and therefore produces repeatable results. These repeatable results are still random in nature since the data is loaded into the database in a random manner.

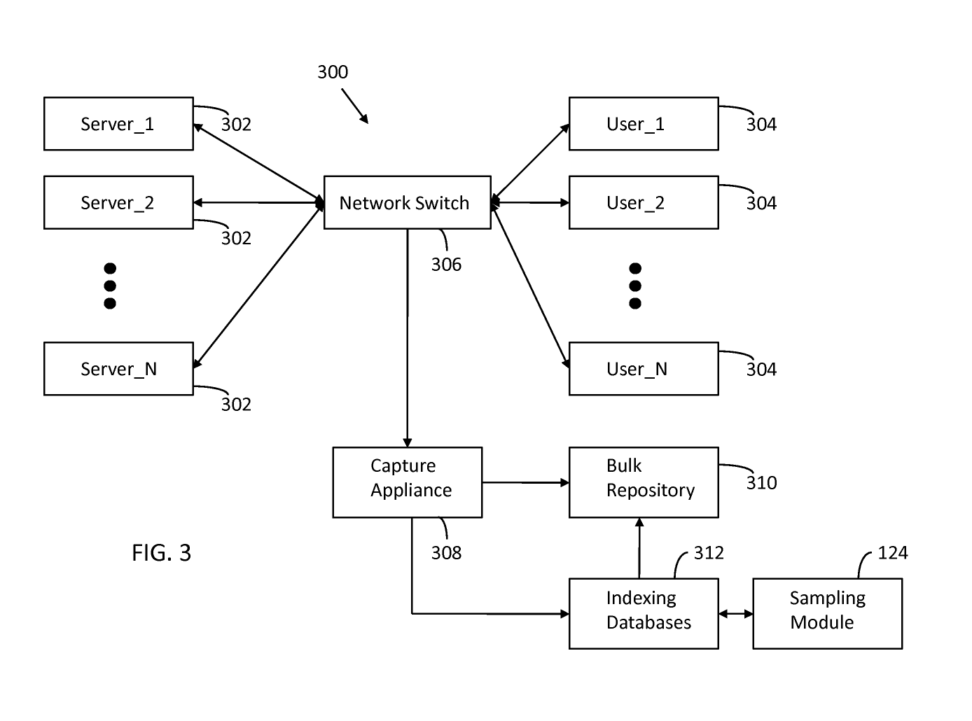

The advantages of the invention are more fully appreciated with reference to the system 300 of FIG. 3. Such a system (without the sampling module 124) is described in commonly owned U.S. Patent Publication 2011/0125749, which is incorporated herein by reference.

System 300 is a communication network that includes devices to capture and record header, flow, and content information of network data packets. In particular, the system 300 includes a set of servers 302 that communicate with a set of users or clients 304 through a network switch 306. A capture appliance 308 is connected to network switch 306. The capture appliance 308 captures and stores all traffic through network switch 306. The capture appliance 308 loads all of the data in a bulk repository 310. The capture appliance 308 operates with indexing databases 312 to form identifiers for data segments. This results in pairs of identifiers and corresponding data segments. One or more attributes are ascribed to each data segment. This results in pairs of identifiers and corresponding attributes. In one embodiment, the sampling module loads pairs of identifiers and corresponding attributes into the indexing database 312 in a random manner.

Since system 300 stores all network traffic, the resultant bulk repository and indexing databases 312 are very large. Therefore, the sampling techniques of the invention are successfully deployed in such a context. However, other contexts, such as data warehouses may also successfully deploy the disclosed techniques.

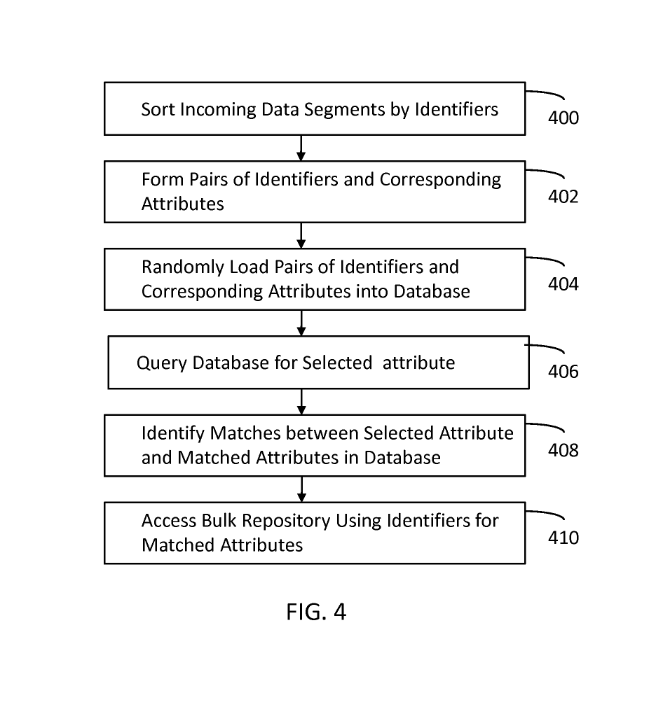

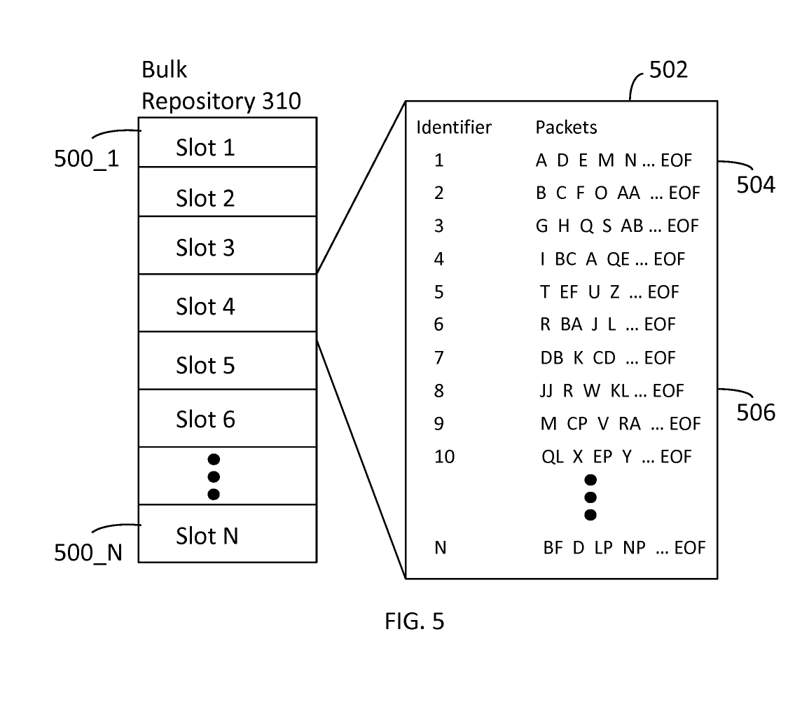

FIG. 4 illustrates simplified processing operations associated with an embodiment of the system of FIG. 3. In one embodiment, incoming data segments are sorted by identifiers 400. FIG. 5 illustrates the bulk repository with a set of storage slots 500_1 through 500_N. Block 502 provides an example of data organization within a slot. Consider a packet stream with individual packets characterized by letters: A B C D E F G H I J K L M N O P Q R S T U V W X Y Z AA AB AC . . . ZZ. Standard techniques are used to assign each packet to a flow, where a flow is an identified communication session. So, as shown at line 504, identifier 1 is associated with packets A D E M N . . . . Each flow is terminated with an end-of-file (EOF) indicator. Thus, FIG. 5 illustrates that bulk repository 310 includes a set of identifiers associated with different packets.

Returning to FIG. 4, pairs of identifiers and corresponding attributes 402 are formed. Each packet may be associated with a set attributes. For example, the attributes may be network data packet parameters. The network data packet parameters may be selected from a version unit, a header length unit, a type of service unit, a total packet length unit, an identification unit, a flags unit, a fragmentation offset unit, a time to live unit, a protocol unit, a check sum unit, a source address unit, a destination address unit and an options unit. Alternately, the attributes may be selected from deep-packet inspection attributes, application identification attributes, application specific metadata attributes, malware analysis attributes, reputation attributes, domain information attributes and country information attributes.

The use of attributes operates to condense the amount of information that is stored in a database. The bulk repository 110 stores the entire data packet. The attributes characterize the stored data. The attributes facilitate the search for information in the bulk repository. That is, a search for a selected attribute results in a match between the selected attribute and corresponding attributes in the database, thereby forming matched corresponding attributes. The matched corresponding attributes have corresponding identifiers.

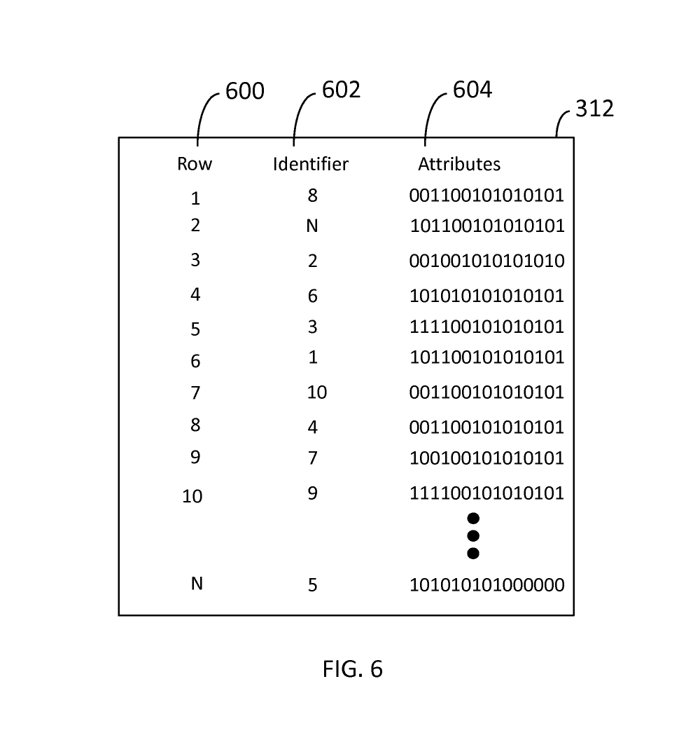

The next operation of FIG. 4 is to randomly load pairs of identifiers and corresponding attributes into a database 404. This operation is appreciated with reference to FIG. 6. FIG. 6 illustrates an indexing database 312 with a column specifying row number 600, an identifier column 602 and an attributes column 604. The attribute column may include binary data specifying attributes, such as HTTP user agent, file name, mime type, and the like.

In the prior art, a row number corresponds with an identifier number since the database is loaded sequentially. However, in accordance with the invention, the identifiers and their corresponding attributes are loaded randomly. In this example, the sequence of values in the identifier column 602 is 8, N, 2, 6, 3, 1, etc.

Permanent read locations may now be designated. For example, permanent read locations may be a first sub-set of the rows in the database. Consider a simple example of a table with 100 rows. If one desired a 10% sample, then the first 10 rows would be designated as the permanent read locations. If one desired a 50% sample, then the first 50 rows would be designated as the permanent read locations. Different random sample sets may also be obtained by varying the starting location. Again, consider the simple example of a table with 100 rows split into 10 different non-overlapping data sample sets, each representing a 10% sample of all data. Each sample set is repeatable and distinct from the other sets. Thus, different result sets can be obtained in a repeatable fashion by varying either or both of the starting segment and starting offset within the starting segment. The foregoing examples specify rows in a database, but any location in the database may be used in accordance with embodiments of the invention.

The remaining operations of FIG. 4 demonstrate how the database may be queried for attributes and back chaining may be used to link the attributes to their corresponding data in the bulk repository. In particular, the database is queried for a selected attribute 406. Matches are identified between the selected attribute and matched attributes in the database 408. The bulk repository is accessed using identifiers for the matched attributes. For example, suppose a query results in a match with attributes associated with identifier 8, which is in the first row of FIG. 6. That identifier may be used as an index into block 502 of FIG. 5. As shown in FIG. 5, identifier 8 at line 506 is associated with packets JJ R W KL . . . , which are in bulk repository 310.

An embodiment of the present invention relates to a computer storage product with a computer readable storage medium having computer code thereon for performing various computer-implemented operations. The media and computer code may be those specially designed and constructed for the purposes of the present invention, or they may be of the kind well known and available to those having skill in the computer software arts. Examples of computer-readable media include, but are not limited to: magnetic media such as hard disks, floppy disks, and magnetic tape; optical media such as CD-ROMs, DVDs and holographic devices; magneto-optical media; and hardware devices that are specially configured to store and execute program code, such as application-specific integrated circuits (“ASICs”), programmable logic devices (“PLDs”) and ROM and RAM devices. Examples of computer code include machine code, such as produced by a compiler, and files containing higher-level code that are executed by a computer using an interpreter. For example, an embodiment of the invention may be implemented using JAVA®, C++, or other object-oriented programming language and development tools. Another embodiment of the invention may be implemented in hardwired circuitry in place of, or in combination with, machine-executable software instructions.

The foregoing description, for purposes of explanation, used specific nomenclature to provide a thorough understanding of the invention. However, it will be apparent to one skilled in the art that specific details are not required in order to practice the invention. Thus, the foregoing descriptions of specific embodiments of the invention are presented for purposes of illustration and description. They are not intended to be exhaustive or to limit the invention to the precise forms disclosed; obviously, many modifications and variations are possible in view of the above teachings. The embodiments were chosen and described in order to best explain the principles of the invention and its practical applications, they thereby enable others skilled in the art to best utilize the invention and various embodiments with various modifications as are suited to the particular use contemplated. It is intended that the following claims and their equivalents define the scope of the invention.

1. A method of sampling data in a database, comprising:
designating permanent read locations in a database;
populating the database with randomly loaded data; and
accessing the permanent read locations in the database to form sampled repeatable results attributable to the permanent read locations and the randomly loaded data.

2. The method of claim 1 wherein accessing includes initially accessing a fixed permanent read location.

3. The method of claim 2 wherein accessing includes initially accessing a permanent read location offset from the fixed permanent read location.

4. The method of claim 1 wherein the randomly loaded data includes network traffic identifiers and corresponding attributes.

5. The method of claim 4 further comprising:
querying the database for a selected attribute;
identifying matches between the selected attribute and corresponding attributes in the database to form matched corresponding attributes, wherein the matched corresponding attributes have corresponding identifiers; and
access a bulk repository using the corresponding identifiers of the matched corresponding attributes, wherein the bulk repository stores data segments by identifiers.

6. The method of claim 5 wherein the data segments are network data packets.

7. The method of claim 5 wherein the corresponding attributes are pre-determined data types.

8. The method of claim 5 wherein the corresponding attributes characterize network data packet parameters.

9. The method of claim 8 wherein the network data packet parameters are selected from a version unit, a header length unit, a type of service unit, a total packet length unit, an identification unit, a flags unit, a fragmentation offset unit, a time to live unit, a protocol unit, a check sum unit, a source address unit, a destination address unit and an options unit.

10. The method of claim 5 wherein the corresponding attributes are selected from deep-packet inspection attributes, application identification attributes, application specific metadata attributes, malware analysis attributes, reputation attributes, domain information attributes and country information attributes.

11. A non-transitory computer readable storage medium, comprising executable instructions to:
sort data segments to form pairs of records and corresponding data segments; and
randomly load the pairs of records and corresponding data segments into a database.

12. The non-transitory computer readable storage medium of claim 11 further comprising executable instructions to sample permanent read locations within the database to form sampled repeatable results attributable to the permanent read locations and the randomly loaded pairs of records and corresponding data segments.

13. The non-transitory computer readable storage medium of claim 12 wherein the permanent read locations are a specified sub-set of locations in the database.

14. The non-transitory computer readable storage medium of claim 13 wherein the permanent read locations include an initial fixed permanent read location.

15. The non-transitory computer readable storage medium of claim 14 wherein the permanent read locations include an initial permanent read location offset from the initial fixed permanent read location.

16. The non-transitory computer readable storage medium of claim 11 wherein the data segments are network data packets.

17. The non-transitory computer readable storage medium of claim 11 wherein the records are pre-determined data types.

18. The non-transitory computer readable storage medium of claim 17 wherein the pre-determined data types are network data packet parameters.

19. The non-transitory computer readable storage medium of claim 18 wherein the network data packet parameters are selected from a version unit, a header length unit, a type of service unit, a total packet length unit, an identification unit, a flags unit, a fragmentation offset unit, a time to live unit, a protocol unit, a check sum unit, a source address unit, a destination address unit and an options unit.
